(19) United States
(12) Patent Application Publication
(10) Pub. No.: US 2025/0132316 A1
(43) Pub. Date: Apr. 24, 2025

(54) MULTI-LAYERED ELECTRODE

(71) Applicant: NORTHVOLT AB, Stockholm (SE)

(72) Inventors: Hwamyung JANG, Stockholm (SE); Léo DUCHÊNE, Västerås (SE)

(21) Appl. No.: 18/836,646

(22) PCT Filed: Feb. 16, 2023
(86) PCT No.: PCT/EP2023/053901

§ 371 Date: Aug. 7, 2024

(30) Foreign Application Priority Data
Feb. 16, 2022 (SE) 2250159-7

(51) Int. Cl. H01M 4/36; H01M 4/02; H01M 4/66; H01M 10/0562; H01M 10/0569

(52) U.S. Cl. CPC H01M 4/366; H01M 4/667; H01M 10/0562; H01M 10/0569; H01M 2004/021; H01M 2004/027; H01M 2220/20

(57) ABSTRACT

The invention relates to a secondary cell comprising an anode, a cathode, optionally a separator, and an electrolyte, characterized in that the anode comprises particles in multiple layers.

### FIELD OF THE INVENTION

The present invention relates to electrodes for secondary cells, and in particular to multi-layered electrodes.

### TECHNICAL BACKGROUND

Rechargeable batteries having high energy density and discharge voltage, in particular Li-ion batteries, are an important component in portable electronic devices and are a key enabler for the electrification of transport and large-scale storage of electricity.

State of the art Li-ion batteries typically consists of stacks of secondary cells, wherein each cell is composed of a cathode comprising a cathode current collector, an electrolyte, an anode comprising an anode current collector, and optionally a separator positioned between the anode and cathode.

In secondary cells where the anodes are made of graphite-based materials and a metal current collector, the cations are extracted from the cathode material and then diffuse from the cathode material through the electrolyte and intercalate into the anode material during charging. During discharge, this process is reversed.

In an effort to increase the energy density, the development has gone towards lithium metal batteries since lithium metal demonstrates a much higher specific capacity and a lower redox potential than graphite. In such batteries, the anode consists of a lithium metal whose corresponding cations carry the current in the electrolyte. However, the use of lithium metal poses several challenges during both manufacturing and cycling of the battery. Lithium metal reacts violently with water and extra precautions are therefore required during assembly of lithium metal battery cells, such as strict dry room conditions, strict waste management and modification of the equipment, to prevent spontaneous ignition. During cycling, lithium metal deposition and dissolution is associated with large volume changes which can reduce the cycling stability of the cell.

Another issue with secondary cells containing lithium metal is the formation of lithium metal dendrites when the corresponding lithium ion is deposited on the anode. That risk increases upon repetition of charging and discharging cycles or during particularly fast charging conditions. This hampers the cycling stability, as some of these dendrites can break off and get electronically disconnected, hence reducing access to otherwise useful charge in the battery. Dendrites also increase the risk for short-circuits in the secondary cell, as dendrites can grow through the electrolyte and the separator, thereby putting the anode in contact with the cathode, resulting in serious fire hazards.

Increasing the uniformity of metal plating is thus important to reduce the risk of dendrite formation as well as to alleviate problems related to large volume changes. One way to achieve this is to confine lithium plating within a porous structure. The high surface area of the porous structure reduces the local current density and the risk of dendrites while the available pore volume allows for lithium deposition without further overall volume change in the layer. However, the porous structure adds weight to the battery reducing the advantages of using a lithium metal anode.

A remaining challenge is to avoid lithium metal deposition on top of the active layer and to promote lithium deposition inside of the porous structure.

### SUMMARY OF THE INVENTION

An object of the present invention is to provide a multi-layer anode for a secondary cell, enabling uniform metal plating.

### BRIEF DESCRIPTION OF THE DRAWINGS

FIG. 1 illustrates lithiation by intercalation and subsequent bottom-up plating according to the invention.

FIG. 2 illustrates prior art unwanted and uneven plating on the surface of an anode with three active layers and a top insulating film.

FIG. 3 shows the N/P ratio in relation to the porosity.

FIG. 4 shows a Tafel plot for lithium metal plating on a fully lithiated hard carbon electrode.

FIG. 5 shows a Tafel plot for lithium metal plating on a fully lithiated graphite electrode.

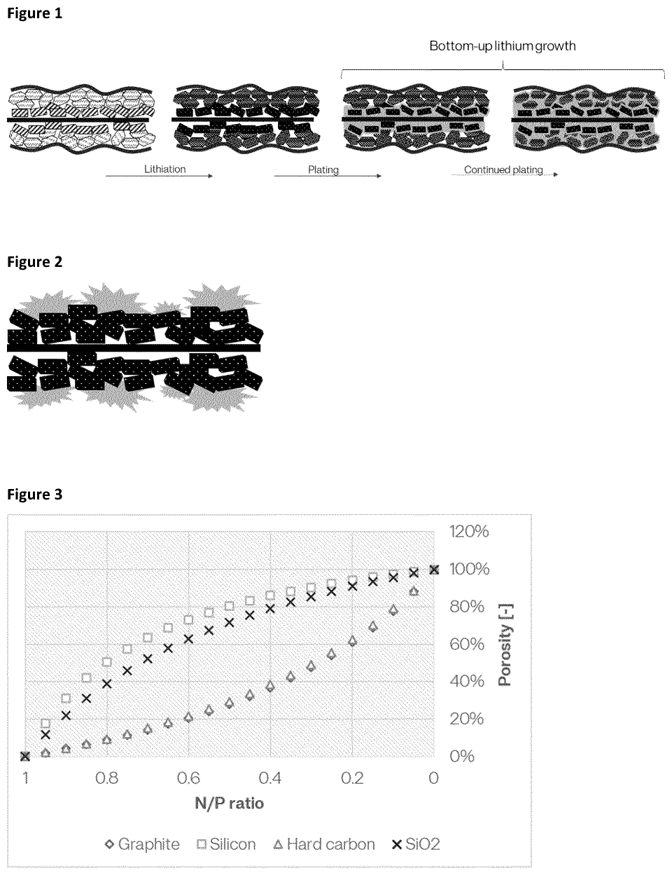

### DETAILED DESCRIPTION OF THE INVENTION

In accordance with a first aspect of the invention, there is disclosed a secondary cell comprising an anode, a cathode, optionally a separator, and an electrolyte, characterized in that the anode comprises an active material or composition of active materials in multiple layers.

The embodiments and aspects disclosed throughout this description may be combined in any combination(s). Making such combinations is well within the abilities of the person skilled in the art.

In one embodiment, the anode comprises particles of the active material or composition of active materials.

The anode may comprise at least two different layers, wherein the active material or composition of active materials within each layer has a different exchange current density for lithium plating. In one embodiment, the anode comprises from 3 to 5 layers. Each layer of the 3 to 5 layers may have a different exchange current density of lithium plating.

In one embodiment the anode layer closest to the separator has a surface with lower exchange current density of lithium plating compared to the other anode layer(s). Each layer having its distinctive exchange current density enables lithium plating in a “bottom up” manner, from the current collector towards the separator. This way an even lithium plating is achieved and non-plated void volumes in the electrode is avoided.

The active material or composition of active materials of at least one layer of the secondary cell may comprise lithium. This is achieved by pre-lithiation of the secondary cell, whereby the active material or composition of active materials has been treated with lithium or lithium ions physically or electrochemically in order to incorporate a certain amount of lithium or lithium ions into the material before the first charging cycle. By incorporating lithium into the material, it is possible to reduce the impact of the irreversible electrochemical losses during the first instances of charging. The amount of incorporated lithium could be adjusted to be at or below the amount corresponding to these irreversible electrochemical losses. The level of lithium incorporation into the material can be adjusted according to preference. The skilled person is well equipped to conduct such adjustments.

Pre-lithiation of the anode will increase the total lithium content in the cell, that can compensate for lost lithium-ion during operation, and improve the total cycle life of the battery.

In one embodiment, the active material or composition of active materials comprises particles which are at least partially pre-lithiated.

In one embodiment, the active material or composition of active materials is saturated with lithium. Suitable compounds for such saturation are for example Li₁₅Si₄, LiC₆, Li₁₃Sn₅, and Li₉Al₄.

In one embodiment, the secondary cell is a lithium secondary cell.

In one embodiment, the active material or composition of active materials of each individual layer has been chosen from the group consisting of non-graphitizing carbon, for example hard carbon, graphite, silicon, silicon oxide (SiOx, x smaller than or equal to 2), silicon-carbon composite, a transition metal dichalcogenide (e.g. titanium disulfide (TiS₂)), tin-cobalt alloy, lithium titanate oxide (LTO, Li₄Ti₅O₁₂), MXenes (two-dimensional transition metal carbides, carbonitrides and nitrides, e.g. V₂CTₓ, Nb₂CTₓ, Ti₂CTₓ, and Ti₃C₂Tₓ) or a combination of at least two of these.

The term “MXenes”, as used herein, represents two-dimensional inorganic compounds making up a-few-atoms-thick layers of transition metal carbides, nitrides, or carbonitrides. MXenes combine the metallic conductivity of transition metal carbides with a hydrophilic character.

In one embodiment, the anode does not include a separate current collector layer. Thereby, large cost savings are obtained, by simplifying the manufacturing process of the anode. For example, by avoiding the use of metal foil, metal mesh, or metal fibers, the number of manufacturing steps are reduced.

In yet another embodiment, the anode has a porosity in the interval of from 10% to 90% of the total volume of the material, preferably from 15% to 75%, more preferably from 25 to 50%. In a preferred porosity interval of from 10% to 30%, lithiation of lithium ions into the active material or composition of active materials is facilitated. In another preferred porosity interval of from 30% to 70%, or from 30% to 60%, plating of lithium metal onto the active material or composition of active materials is facilitated. After lithiation, lithium ions are stored within the anode material or composition of active materials without occupying any of the void volume constituting the pores. Whereas, in accordance with the invention, the lithium plating takes place on the surface of the pores of the active material or composition of active materials, effectively filling the void volume without causing any substantial volume change of the anode. This is especially important during repeated charging cycles. The present invention improves the cycling stability and reduces the risk for early secondary cell failure, both under normal and high current operations.

During continuous cycling, plating of the anode at the top layer (illustrated by FIG. 2) may result in unfavorable dendritic growth of Li metal and/or increased cell volume. To favor lithium growth inside the porous anode layer, a gradient of interfacial activity is created by the multilayer anode structure. This gradient of interfacial activity is the result of a variation of the exchange current density for lithium plating at the surface of the different active materials composing each layer. As a result, Li metal starts to deposit bottom-up in the anode, gradually filling the void spaces.

The void space is, in accordance with the present invention, large enough to accommodate the total volume of plated lithium. Hence, the porosity of the layer can be optimized through the choice of active material or composition of active materials, as well as the ratio between lithiated lithium ions and plated lithium metal. The skilled person is well equipped to make such an optimization.

The minimum porosity of the anode may be calculated according to formula (1) as shown below.

$$P = \frac{( 1 - r ) {C}_{a} \cdot {ρ}_{a}}{r \cdot {C}_{a} \cdot {ρ}_{a} + ( 1 - r ) {C}_{Li} \cdot {ρ}_{Li}} \qquad ( 1 )$$

wherein P is the porosity, r is the N/P ratio, Cₐ is the anode specific capacity, or in the case of a composition of active material the weighted average anode specific capacity, [mAh/g], ρₐ is the anode active material density, or in the case of a composition of active material the weighted average anode active material density, [g/cm³], C_{Li} is the lithium specific capacity [mAh/g](3862 mAh/g), and ρ_{Li} is the lithium density [g/cm³](0.53 g/cm³). The term “N/P ratio” is used herein for the capacity ratio between the anode (the negative electrode) and cathode (the positive electrode). Finding the anode specific capacity for the anode material and lithium specific capacity is common knowledge in the field. FIG. 3 shows the relation between the porosity, P, for a selection of active materials and the N/P ratio.

In one embodiment the anode loading amount to the cathode loading amount (N/P ratio) is 0.01 to 0.99, preferably 0.25 to 0.75, more preferably 0.3 to 0.5.

In one embodiment the anode has a porosity in the range of P to 1.25*P, where P is defined as the porosity according to formula (1).

In yet one embodiment, there is a different active material or composition of active materials in each layer of the anode. This enables the formation of an interfacial activity gradient allowing lithium plating in a “bottom up” manner, which maximizes the plating capacity by reducing non-plated voids. This way an even lithium plating is achieved and non-plated void volumes in the electrode is avoided.

In another embodiment, each layer of the anode has a different coating, or one layer is not coated and the remainder of the layers each have a different coating. The coating allows control of the exchange current density for lithium plating at the surface of the different active materials and enables forming a interfacial activity gradient. Li plating can be facilitated by either activating the bottom region of the anode and/or reducing the interfacial activity of the top region of the anode with a coating. Through a synergistic effect of combining activating the bottom region and suppressing the interfacial activity of the top region, bottom-up growth of Li metal is facilitated.

The coating(s) may be chosen from the group consisting of a surface functional group, for example, OH, COOH, CSOH, CONH₂, CSNH₂, NH, NH₂, SH, CN, NO₂ and triazolium; non-graphitizing carbon; a metal or metalloid, for example Si, Sn, Al, Zn, Ag, In, Mg a metal oxide, for example, Al₂O₃, LiAlO₂, ZnO, MnO₂, Co₃O₄, SnO₂, SiOₓ (x smaller than or equal to 2), V₂O₅, CuₓO (1≤x≤2), TiO2, Li₂O, Li₂O₂, ZrO₂, MgO, Ta₂O₅, Nb₂O₅, LiAlO₂, Li₇La₃Zr₂O₁₂ (LLZO), Li₄Ti₅O₁₂ (LTO), B₂O₃, Li₃BO₃—Li₂CO₃; a metal fluoride, for example AlF₃, LiF; a metal phosphate, for example AlPO₄, Li₃PO₄, Li_{1.3}Al_{0.3}Ti_{1.7}(PO₄)₃(LATP); piezoelectric material, such as BaTiO₃, PbZrₓTi₁₋ₓO₃ where x is any number between 1 and 10; a metal hydroxide, such as AlO(OH) (boehmite), Mg(OH)₂, Al(OH)₃; a metal or metalloid nitride, such as AlN, BN, Si₃N₄; Al(NO₃)₃; BaSO₄; or a polymer or polymer electrolyte, containing for example polyvinylidene fluoride (PVDF), preferably in its beta phase, PVDF-HFP, PMMA, PEO, polysiloxane, for example PDMS, lithium polyacrylate (Li-PAA); and mixtures thereof.

The particles, and/or coating(s) of the invention may be functionalized with a moiety chosen from the group consisting of OH, COOH, CSOH, CONH₂, CSNH₂, NH, NH₂, SH, CN, NO₂ and triazolium. Coating(s) and/or functionalizations thereof help in increasing the uniformity of the metal plating by increasing the affinity between the anode surface and lithium metal, which reduces the risk of dendrite formation.

In one embodiment, the anode comprises an electronically insulating film coating the layer closest to the separator, when present. This prevents plating on the layer immediately under the insulating film, and hence reduces the risk for dendrite formation and incomplete plating.

The electronically insulating film comprises a material that has been chosen from the group consisting of Al₂O₃, BaTiO₃, PbZrₓTi₁₋ₓO₃ where x is any number between 1 and 10, Li₂O, LiF, a fluoropolymer for example polyvinylidene fluoride (PVDF), preferentially in its beta phase, PVDF-HFP, PMMA, PEO, polysiloxane for example PDMS, lithium polyacrylate (Li-PAA) and mixtures thereof.

Lithium plating near the current collector can be facilitated by either activating the bottom region of the anode or suppressing the interfacial activity of the top region of the anode with an insulating film. Through a synergistic effect of combining activating the bottom region and suppressing the interfacial activity of the top region, bottom-up growth of Li metal is facilitated.

In one embodiment, one of the layers of the anode is a current collector. Alternatively, the anode may comprise a separate current collector. The separate current collector may be in the form of a foil or in the form of a mesh.

In one embodiment, the foil is coated with a material that has been chosen from the group consisting of C, Si, Sn, Al, Zn, Ag, In, Mg. The coating material may further promote the growth of lithium metal first near the current collector, as opposed to the top of the anode layer.

In one embodiment, the electrolyte of the secondary cell is a liquid electrolyte comprising at least one lithium salt and at least one or more solvents selected from the group consisting of carbonate solvents and their fluorinated equivalents, diC₁₋₄ ethers and their fluorinated equivalents and ionic liquids.

The lithium salt may be one or more salts selected from the group consisting of lithium hexafluorophosphate (LiPF₆), lithium bis(fluorosulfonyl)imide (LiFSI), lithium bis(trifluoromethanesulfonyl)imide (LiTFSI), lithium (fluorosulfonyl) (trifluoromethanesulfonyl) imide (LiFTFSI), lithium bis(pentafluoroethanesulfonyl)imide (LiBETI), lithium (pentafluoroethanesulfonyl)(trifluoromethanesulfonyl)imide (LiPTFSI), lithium trifluoromethanesulfonate (LiOTf), lithium bis(oxalato)borate (LiBOB), lithium difluoro(oxalato)borate (LiDFOB), lithium difluorobis(oxalato)phosphate (LiDFOP), lithium tetrafluoro(oxalato)phosphate (LiTFOP), lithium tetrafluoroborate (LiBF₄), lithium nitrate (LiNO₃) lithium 2-trifluoromethyl-4,5-dicyanoimidazole (LiTDI).

The solvent may be selected from the group consisting of 1,2-dimethoxyethane (DME), N-propyl-N-methylpyrrolidinium bis(fluorosulfonyl)imide (PYR13-FSI), N-propyl-N-methylpyrrolidinium bis(trifluoromethanesulfonyl)imide (PYR13-TFSI), 1-butyl-1-methylpyrrolidinium bis(fluorosulfonyl)imide (PYR14-FSI), 1-butyl-1-methylpyrrolidinium bis(trifluoromethanesulfonyl)imide (PYR14-TFSI), 1-ethyl-3-methylimidazolium bis(fluorosulfonyl)imide (EMIM-FSI), 1-ethyl-3-methylimidazolium bis(trifluoromethanesulfonyl)imide (EMIM-TFSI), dimethyl carbonate (DMC), ethyl methyl carbonate (EMC), diethyl carbonate (DEC), ethylene carbonate (EC), and propylene carbonate (PC), and their fluorinated equivalents.

In one embodiment of the invention, when the electrolyte is a solid electrolyte, said solid electrolyte has been chosen from the group comprising or consisting of Li₂S—P₂S₅, Li₃PS₄, Li₇P₃S₁₁ LLZO-based materials for example Li₇La₃Zr₂O₁₂, Li_{6.24}La₃Zr₂Al_{0.24}O_{11.98}, Li_{6.4}La₃Zr_{1.4}Ta_{0.6}O₁₂; Li_{0.34}La_{0.56}TiO₃ (LLTO); Li_{1.3}Al_{0.3}Ti_{1.7}(PO₄)₃(LATP); thio-LISICON for example Li₁₀MP₂X₁₂ (M=Si or Ge; 8 X═S or Se); lithium argyrodite Li_{6+y}M_{y}^{IV} M_{1-y}^{V}S₅X (X═Cl, Br, or I; M^{IV} is a group IV element for example Si, Ge or Sn; M^{V} is a group V element for example P or Sb; and 0≤y≤1), polymer-based solid electrolytes, for example PEO-LiTFSI mixtures, lithium hydrido-borates LiₓB_{y}H_{z} (x=1 or 2, 1≤y≤12, 4≤z≤14) and lithium hydrido-carba-borates LiCₓB_{y}H_{z} (x=1 or 2, 9≤y≤11, 12≤z≤14).

A second aspect of the invention relates to a vehicle comprising a secondary cell according to the invention disclosed herein.

### EXAMPLES

### Example 1—Tafel Plots

### Hard Carbon Electrode

A two-electrode half-cell was made, comprising a working electrode, a counter electrode, an electrolyte, and a polyethylene separator. The working electrode was a hard carbon anode, containing >96% active material and having an areal capacity of 2 mAh/cm². The counter electrode was lithium metal in large excess. The electrolyte was LiFSI:dimethoxyethane (DME):1,1,2,2-Tetrafluoroethyl 2,2,3,3-Tetrafluoropropyl Ether) (TTE) in a 1:1.2:3 molar ratio. The hard carbon anode was slowly lithiated to a potential of 0 V at a rate of 0.1 mA/cm². The potential was then held constant at 0 V until the current decayed to <0.01 mA/cm². Thereafter, the voltage was altered from the rest potential, which was near 0 V, to −0.1 V at 1 mV/s, followed by a 10 min rest, and a second voltage sweep from the rest potential of near 0 V to 0.1 V at 1 mV/s.

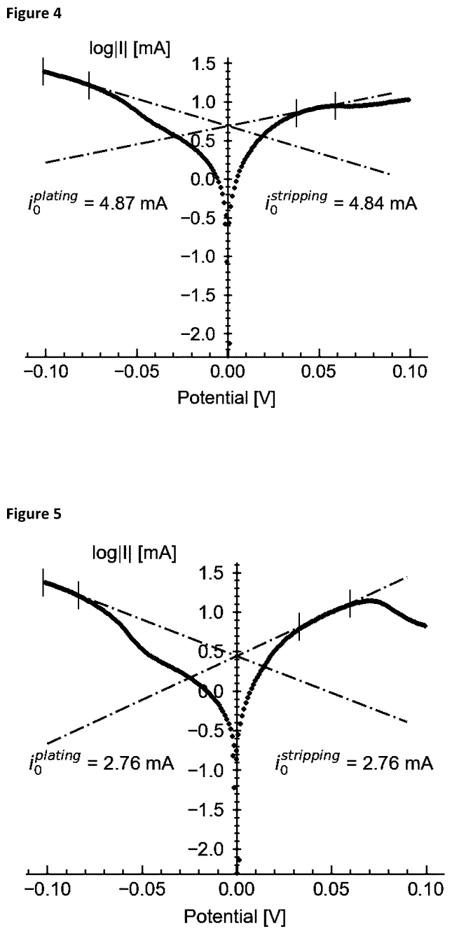

The result of the measurement is shown in a Tafel plot presented in FIG. 4, wherein the experimental data showing the measured current at a given potential is represented by the dots. The dashed lines are linear fits to the data points where they form a near linear regime. In the figure, the data points used for the linear extrapolations are indicated by the small vertical lines crossing the curves for plating and stripping, respectively. The exchange current is found where the two extrapolated lines cross the Y-axis.

### Graphite Electrode

A half-cell was made using a fully lithiated graphite electrode as the working electrode. The counter electrode, electrolyte, separator and the experimental procedure were the same as when using a hard carbon electrode, as described above. The results obtained are shown in a Tafel plot presented in FIG. 5.

Exchange current density is calculated per unit area. As it is difficult to accurately measure the true electrochemical active surface area (EASA) of the anode, the total area of the active material powder was used, calculated from the measured Brunauer-Emmett-Teller (BET) surface area and the mass of active material in the electrode. This calculated area is necessarily higher than the true EASA, but it is assumed to be more accurate compared to using the geometric area of the electrode. The results are shown in table 1.

TABLE 1
Calculated exchange current density values.

| | | | Mass of | Exchanged current |
|---|---|---|---|---|
| | BET surface | Exchange | active | density normalized |
| | area | current | material | to powder area |
| | [cm²/mg] | [mA] | [mg] | (mA/cm²) |
| Graphite | 16 | 2.76 | 14.32 | 1.20E−02 |
| Hard carbon | 23 | 4.85 | 12.52 | 1.68E−02 |

1-28. (canceled)

29. A secondary cell comprising an anode, a cathode, optionally a separator, and an electrolyte, characterized in that the anode comprises an active material or a composition of active materials in multiple layers.

30. The secondary cell according to claim 29, wherein the anode comprises particles of the active material or composition of active materials.

31. The secondary cell according to claim 29, wherein the anode comprises at least two different layers, and wherein the layers have different exchange current densities of lithium plating.

32. The secondary cell according to claim 29, wherein the anode comprises from 3 to 5 layers.

33. The secondary cell according to claim 29, wherein the anode does not include a separate current collector layer.

34. The secondary cell according to claim 29, wherein the anode layer closest to the separator has a surface with lower exchange current density of lithium plating compared to the other anode layer(s).

35. The secondary cell according to claim 29, wherein the anode has a porosity in the interval of from 10% to 90% of the total volume of the anode, preferably from 15% to 75%, more preferably from 25 to 50%.

36. The secondary cell according to claim 29, wherein the anode has a minimum porosity as defined by formula (1):
$$P = \frac{( 1 - r ) {C}_{a} \cdot {ρ}_{a}}{r \cdot {C}_{a} \cdot {ρ}_{a} + ( 1 - r ) {C}_{Li} \cdot {ρ}_{Li}} \qquad ( 1 )$$
wherein P is the porosity, r is the N/P ratio, Cₐ is the anode specific capacity, or in the case of a composition of active materials the weighted average anode specific capacity, [mAh/g], ρₐ is the anode active material density, or in the case of a composition of active materials the weighted average anode active material density [g/cm³], C_{Li} is the lithium capacity [mAh/g], and ρ_{Li} is the lithium density [g/cm³].

37. The secondary cell according to claim 36, wherein the anode has a porosity in the range of P to 1.25*P, where P is defined as the porosity according to formula (1).

38. The secondary cell according to claim 29, wherein each layer of the anode has a different coating, or wherein one layer is not coated and the remainder of the layers each has a different coating.

39. The secondary cell according to claim 38, wherein the coating(s) have been chosen from the group consisting of surface functional groups, for example, OH, COOH, CSOH, CONH₂, CSNH₂, NH, NH₂, SH, CN, NO₂ and triazolium; non-graphitizing carbon; a metal or metalloid, for example Si, Sn, Al, Zn, Ag, In, and Mg; a metal oxide, for example, Al₂O₃, LiAlO₂, ZnO, MnO₂, Co₃O₄, SnO₂, SiOₓ (x smaller than or equal to 2), V₂O₅, CuₓO (1≤x≤2), TiO₂, Li₂O, Li₂O₂, ZrO₂, MgO, Ta₂O₅, Nb₂O₅, LiAlO₂, Li₇La₃Zr₂O₁₂ (LLZO), Li₄Ti₅O₁₂ (LTO), B₂O₃, Li₃BO₃—Li₂CO₃; a metal fluoride, for example AlF₃, LiF; a metal phosphate, for example AlPO₄, Li₃PO₄, Li_{1.3}Al_{0.3}Ti_{1.7}(PO₄)₃ (LATP); piezoelectric material, such as BaTiO₃, PbZrₓTi₁₋ₓO₃ where x is any number between 1 and 10; a metal hydroxide, such as AlO(OH) (boehmite), Mg(OH)₂, Al(OH)₃; a metal or metalloid nitride, such as AlN, BN, Si₃N₄; Al(NO₃)₃; BaSO₄; or a polymer or polymer electrolyte, containing for example polyvinylidene fluoride (PVDF), preferably in its beta phase, PVDF-HFP, PMMA, PEO, polysiloxane, for example PDMS, lithium polyacrylate (Li-PAA); and mixtures thereof.

40. The secondary cell according to claim 29, wherein the particles, and/or coating(s), have been functionalized with a moiety chosen from the group consisting of OH, COOH, CSOH, CONH₂, CSNH₂, NH₂, SH, CN, NO₂ and triazolium.

41. The secondary cell according to claim 29, wherein there is a different active material or composition of active materials in each layer of the anode.

42. The secondary cell according to claim 29, wherein the active material or composition of active materials of at least one layer comprises metallic lithium.

43. The secondary cell according to claim 29, wherein the active material or composition of active materials of each individual layer has been chosen from the group consisting of non-graphitizing carbon, graphite, silicon, silicon oxide (SiOx, x smaller than or equal to 2), silicon-carbon composite, a transition metal dichalcogenide (e.g. titanium disulfide (TiS₂)), tin-cobalt alloy, lithium titanate oxide (LTO, Li₄Ti₅O₁₂), MXenes (e.g. V₂CTₓ, Nb₂CTₓ, Ti₂CTₓ, and Ti₃C₂Tₓ), or a combination of at least two of these.

44. The secondary cell according to claim 29, wherein the active material or composition of active materials comprises particles which are at least partially pre-lithiated.

45. The secondary cell according to claim 29, wherein the active material or composition of active materials comprises Li₁₅Si₄, LiC₆, Li₁₃Sn₅, or Li₉Al₄.

46. The secondary cell according to claim 29, wherein the anode comprises an electronically insulating film coating the layer closest to the separator.

47. The secondary cell according to claim 46, wherein the electronically insulating film comprises a material that has been chosen from the group consisting of Al₂O₃, BaTiO₃, Li₂O, LiF, a fluoropolymer for example polyvinylidene fluoride (PVDF), preferentially in its beta phase, PVDF-HFP, PMMA, PEO, polysiloxane, for example PDMS, lithium polyacrylate (Li-PAA), and mixtures thereof.

48. The secondary cell according to claim 29, wherein one of the layers of the anode is a current collector, or wherein the anode comprises a separate current collector.

49. The secondary cell according to claim 48, wherein the separate current collector is in the form of a foil.

50. The secondary cell according to claim 48, wherein the separate current collector is in the form of a mesh.

51. The secondary cell according to claim 49, wherein the foil is coated with a material that has been chosen from the group consisting of C, Si, Sn, Al, Zn, Ag, In, Mg.

52. The secondary cell according to claim 29, wherein the electrolyte is a liquid electrolyte comprising at least one lithium salt and at least one or more solvents selected from the group consisting of carbonate solvents and their fluorinated equivalents, diC₁₋₄ ethers and their fluorinated equivalents and ionic liquids.

53. The secondary cell according to claim 52, wherein the lithium salt is one or more selected from the group consisting of lithium hexafluorophosphate (LiPF₆), lithium bis(fluorosulfonyl)imide (LiFSI), lithium bis(trifluoromethanesulfonyl)imide (LiTFSI), lithium (fluorosulfonyl) (trifluoromethanesulfonyl) imide (LiFTFSI), lithium bis(pentafluoroethanesulfonyl)imide (LiBETI), lithium (pentafluoroethanesulfonyl)(trifluoromethanesulfonyl)imide (LiPTFSI), lithium trifluoromethanesulfonate (LiOTf), lithium bis(oxalato)borate (LiBOB), lithium difluoro(oxalato)borate (LiDFOB), lithium difluorobis(oxalato)phosphate (LiDFOP), lithium tetrafluoro(oxalato)phosphate (LiTFOP), lithium tetrafluoroborate (LiBF₄), lithium nitrate (LiNO₃) lithium 2-trifluoromethyl-4,5-dicyanoimidazole (LiTDI).

54. The secondary cell according to claim 52, wherein the solvent is selected from the group consisting of 1,2-dimethoxyethane (DME), N-propyl-N-methylpyrrolidinium bis(fluorosulfonyl)imide (PYR13-FSI), N-propyl-N-methylpyrrolidinium bis(trifluoromethanesulfonyl)imide (PYR13-TFSI), 1-butyl-1-methylpyrrolidinium bis(fluorosulfonyl)imide (PYR14-FSI), 1-butyl-1-methylpyrrolidinium bis(trifluoromethanesulfonyl)imide (PYR14-TFSI), 1-ethyl-3-methylimidazolium bis(fluorosulfonyl)imide (EMIM-FSI), 1-ethyl-3-methylimidazolium bis(trifluoromethanesulfonyl)imide (EMIM-TFSI), dimethyl carbonate (DMC), ethyl methyl carbonate (EMC), diethyl carbonate (DEC), ethylene carbonate (EC), and propylene carbonate (PC), and their fluorinated equivalents.

55. The secondary cell according to claim 29, wherein the electrolyte is a solid electrolyte comprising Li₂S—P₂S₅, Li₃PS₄, LLZO-based materials, for example Li₇La₃Zr₂O₁₂, Li_{6.24}La₃Zr₂Al_{0.24}O_{11.98}, Li_{6.4}La₃Zr_{1.4}Ta_{0.6}O₁₂; Li_{0.34}La_{0.56}TiO₃ (LLTO), Li_{1.3}Al_{0.3}Ti_{1.7}(PO₄)₃ (LATP), thio-LISICON (Li₁₀MP₂X₁₂; M=Si or Ge; X═S or Se), lithium argyrodite Li₆PS₅X (X ═Cl, Br, I and combination thereof), polymer based solid electrolytes, lithium hydrido-borates and lithium hydrido-carba-borates LiₓCB_{y-1}H_{z} (x=1 or 2; 1≤y≤12, 4≤z≤12).

56. Vehicle comprising the secondary cell according to claim 29.
